(19) United States
(12) Patent Application Publication
(10) Pub. No.: US 2016/0283017 A1
(43) Pub. Date: Sep. 29, 2016

(54) HYBRID DETECTION FOR A CAPACITANCE INPUT DEVICE

(71) Applicant: Synaptics Incorporated, San Jose, CA (US)

(72) Inventor: Nickolas Fotopoulos, San Jose, CA (US)

(21) Appl. No.: 14/671,901

(22) Filed: Mar. 27, 2015

(51) Int. Cl. G06F 3/041; G06F 3/044

(52) U.S. Cl. CPC G06F 3/0416; G06F 3/044; G06F 3/0412; G06F 2203/04106

(57) ABSTRACT

A processing system for hybrid detection includes a sensor module and a determination module. The sensor module is coupled to sensor electrodes, and is configured to drive a first subset of sensor electrodes with transmitter signals, and receive, based on the transmitter signals, first resulting signals from a second subset of the sensor electrodes. The sensor module is further configured to receive second resulting signals from the second subset while the second subset are driven with modulated signals. The determination module is configured to determine a set of contiguous regions based on the first resulting signals, determine a number of unmatched contiguous regions in the set of contiguous regions based on measurements processed from the second resulting signals, and change an operating mode when the number of unmatched contiguous regions satisfies a threshold number.

### FIELD

This invention generally relates to electronic devices.

### BACKGROUND

Input devices, including proximity sensor devices (also commonly called touchpads or touch sensor devices), are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, embodiments relate to a processing system for hybrid detection that includes a sensor module and a determination module. The sensor module is coupled to sensor electrodes, and is configured to drive a first subset of sensor electrodes with transmitter signals, and receive, based on the transmitter signals, first resulting signals from a second subset of the sensor electrodes. The sensor module is further configured to receive second resulting signals from the second subset while the second subset are driven with modulated signals. The determination module is configured to determine a set of contiguous regions based on the first resulting signals, determine a number of unmatched contiguous regions in the set of contiguous regions based on measurements processed from the second resulting signals, and change an operating mode when the number of unmatched contiguous regions satisfies a threshold number.

In general, in one aspect, embodiments relate to a method for hybrid detection. The method includes determining a set of contiguous regions based on first resulting signals obtained by driving a first subset of sensor electrodes with transmitter signals and receiving, based on the transmitter signals, the first resulting signals from a second subset of sensor electrodes. The method further includes determining a number of unmatched contiguous regions in the set of contiguous regions based on measurements processed from the second resulting signals received by driving the second subset with modulated signals, and changing an operating mode when the number of unmatched contiguous regions satisfies a threshold number.

In general, in one aspect, embodiments relate to an input device for hybrid detection. The input device includes sensor electrodes including a first subset and a second subset. The input device further includes a processing system configured to determine a set of contiguous regions based on resulting signals obtained by driving the first subset with transmitter signals and receiving, based on the transmitter signals, first resulting signals from the second subset. the processing system is further configured to determine a number of unmatched contiguous regions in the set of contiguous regions based on measurements processed from second resulting signals received by driving the second subset with modulated signals, and change an operating mode when the number of unmatched contiguous regions satisfies a threshold number.

Other aspects of the invention will be apparent from the following description and the appended claims.

### BRIEF DESCRIPTION OF DRAWINGS

The preferred exemplary embodiment of the present invention will hereinafter be described in conjunction with the appended drawings, where like designations denote like elements.

FIGS. 1-3 are block diagrams of example systems in accordance with an embodiment of the invention.

FIGS. 4 and 5 are an example flowcharts in accordance with one or more embodiments of the invention.

FIG. 6 is an example in accordance with one or more embodiments of the invention.

### DETAILED DESCRIPTION

The following detailed description is merely exemplary in nature, and is not intended to limit the invention or the application and uses of the invention. Furthermore, there is no intention to be bound by any expressed or implied theory presented in the preceding technical field, background, brief summary or the following detailed description.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the present invention provide input devices and methods that facilitate improved usability. In particular, one or more embodiments are directed to hybrid detection. A set of contiguous regions are determined based on resulting signals of mutual capacitance sensing. A number of unmatched contiguous regions are determined from the set of contiguous regions based on absolute capacitance measurements. When the number of unmatched contiguous regions satisfies a threshold, a mode of operation is changed.

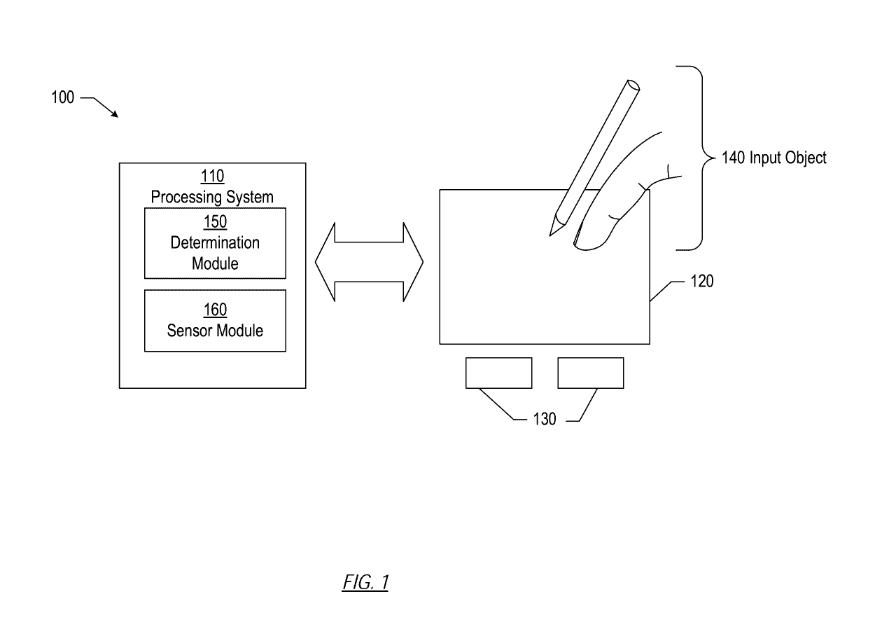

Turning now to the figures, FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) may be part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (140) in a sensing region (120). Example input objects include fingers and styli, as shown in FIG. 1. Throughout the specification, the singular form of input object is used. Although the singular form is used, multiple input objects may exist in the sensing region (120). Further, which particular input objects are in the sensing region may change over the course of one or more gestures. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher-dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may be a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of, or all of, one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows only a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may be configured for both display updating and input sensing. As another example, the display screen may be operated in part or in total by the processing system (110).

It should be understood that while many embodiments of the invention are described in the context of a fully-functioning apparatus, the mechanisms of the present invention are capable of being distributed as a program product (e.g., software) in a variety of forms. For example, the mechanisms of the present invention may be implemented and distributed as a software program on information-bearing media that are readable by electronic processors (e.g., non-transitory computer-readable and/or recordable/writable information bearing media that is readable by the processing system (110)). Additionally, the embodiments of the present invention apply equally, regardless of the particular type of medium used to carry out the distribution. For example, software instructions in the form of computer readable program code to perform embodiments of the invention may be stored, in whole or in part, temporarily or permanently, on a non-transitory computer-readable storage medium. Examples of non-transitory, electronically-readable media include various discs, physical memory, memory, memory sticks, memory cards, memory modules, and or any other computer readable storage medium. Electronically-readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the invention. For example, various components may be combined to create a single component. As another example, the functionality performed by a single component may be performed by two or more components.

FIG. 2 shows an example block diagram for moisture detection in accordance with one or more embodiments of the invention. As shown in FIG. 2, the determination module (150) may be connected to a data repository (200). The data repository (200) may correspond to any type of storage unit or device for storing data. For example, data repository (200) may correspond to hardware registers, memory modules, data structures, or any other component or a combination thereof.

As shown in FIG. 2, the data repository includes functionality to store one or more profiles (202) and contiguous regions (204). A profile (202) is a collection of capacitive measurements acquired in a single frame through absolute capacitance sensing in accordance with one or more embodiments of the invention. Each profile may be along an axis of the sensing region. Thus, a profile represents a one dimensional collection of measurements.

A contiguous region (204) is a connected section of a sensing region in which each measurement in the connected section satisfies at least one condition indicating a presence of an input object as compared to other locations in the sensing region. In other words, when a measurement satisfies the condition, an input object may be located at the corresponding position of the measurement. For example, the condition may be a threshold value for the measurement. By way of another example, the condition may be based on shape, size, polarity, temporal characteristics, or other characteristics or a combination thereof. Contiguous regions (204) may be unmatched contiguous regions (206) and matched contiguous regions (208).

An unmatched contiguous region (206) is a contiguous region that does not match the measurements acquired via absolute capacitance sensing in accordance with one or more embodiments of the invention. In other words, an unmatched contiguous region (206) is a contiguous region that is not corroborated by absolute capacitance measurements.

A matched contiguous region (208) is a contiguous region that matches absolute capacitance measurements. In particular, a matched contiguous region (208) is corroborated by one or more absolute capacitance measurements. The corroboration may indicate that the contiguous region may correspond to an input object. For example, ghost fingers and water droplets may be reflected in the mutual capacitance measurements and not reflected in the absolute capacitance measurements.

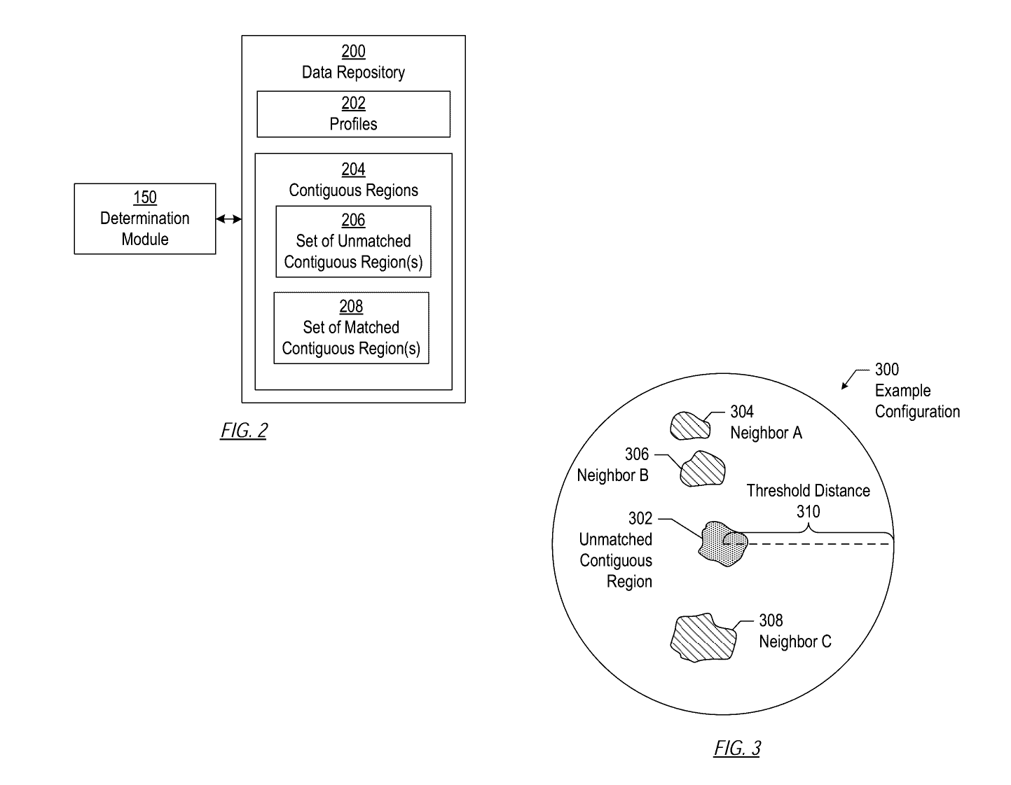

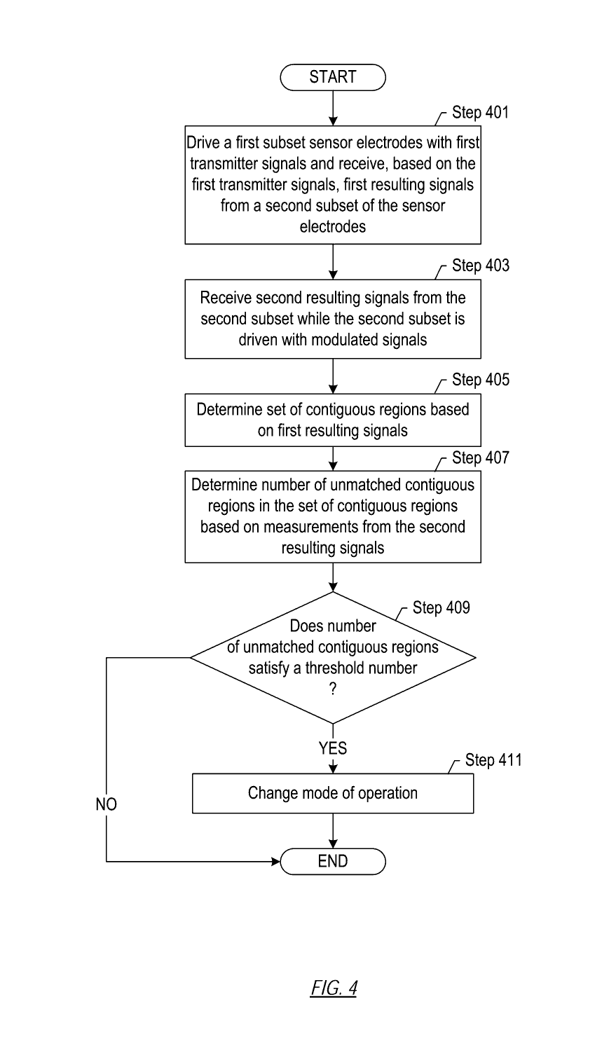

FIG. 3 shows an example configuration (300) in accordance with one or more embodiments of the invention. In the example, an unmatched contiguous region (302) has neighbors (e.g., neighbor A (304), neighbor B (306), neighbor C (308)). A neighbor of a particular contiguous region is a contiguous region that is within a threshold distance (310) to the particular contiguous region. The threshold distance may be a numerical value and may be configurable in accordance with one or more embodiments of the invention.

In one or more embodiments of the invention, neighbors may or may not be adjacent to or within line of sight to the particular contiguous region. For example, as shown in FIG. 3, neighbor B (306) is between neighbor A (304) and unmatched contiguous region (302).

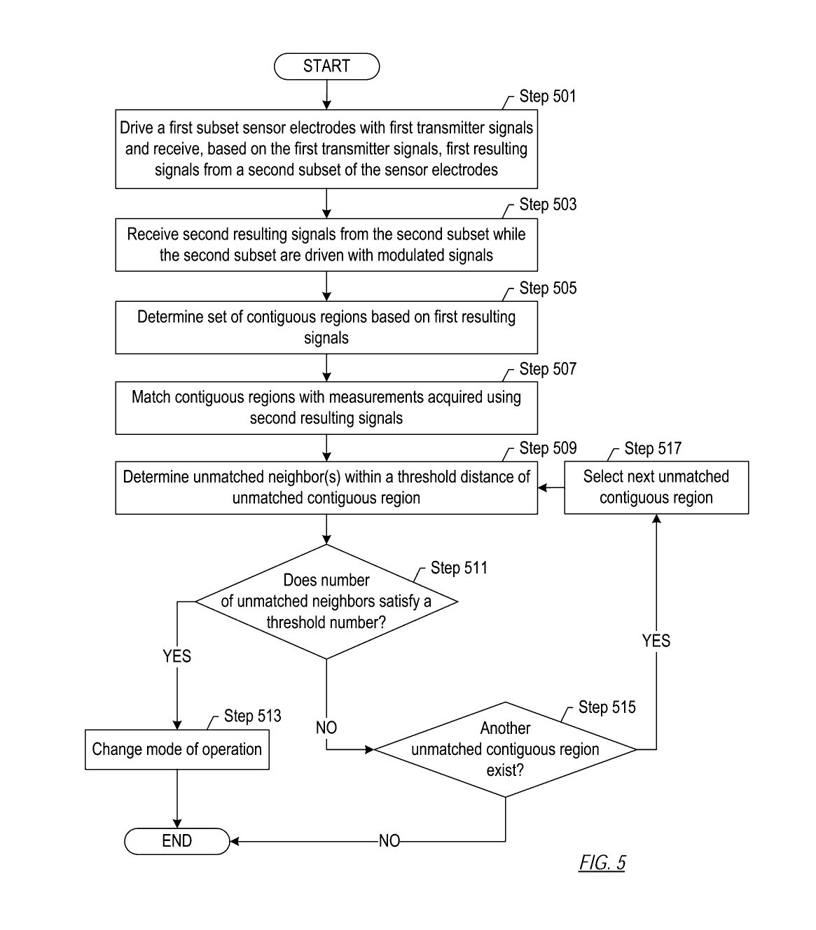

FIGS. 4 and 5 show flowcharts in accordance with one or more embodiments of the invention. While the various steps in these flowcharts are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

FIG. 4 shows a flowchart in accordance with one or more embodiments of the invention. For example, the steps of FIG. 4 may be performed by the processing system, such as a combination of the sensor module and the determination module.

In Step 401, a first subset of sensor electrodes is driven with first transmitter signals. Further, first resulting signals that are based on the first transmitter signals are received with a second subset of sensor electrodes. In accordance with one or more embodiments of the invention, the subsets of sensor electrodes that transmit the first transmitter signals are different than the subset of receiver electrodes that receive the resulting signals. Further, the resulting signals reflect the transmitter signals, as well as environmental effects and input objects that may be present in the sensing region. In one or more embodiments of the invention, Step 401 corresponds to performing mutual capacitive sensing of the sensing region.

In Step 403, second resulting signals are received from the second subset while the second subset is driven with modulated signals. In one or more embodiments of the invention, sensor electrodes receive resulting signals while being modulated by absolute capacitive signals The sensor electrodes that are modulated with the absolute capacitive signals are the same as the sensor electrodes that receive the resulting signals. The sensor electrodes that are modulated and receive in Step 403 may be all or a subset of the total sensor electrodes of the input device. Additionally, third resulting signals may be received from the first subset while the first subset is driven with modulated signals. The resulting signals reflect the modulated signals, as well as environmental effects and input objects that may be present in the sensing region. In one or more embodiments of the invention, Step 403 corresponds to performing absolute capacitive sensing of the sensing region.

In Step 405, a set of contiguous regions are determined based on the first resulting signals in accordance with one or more embodiments of the invention. In one or more embodiments of the invention, capacitive measurements are acquired for the first resulting signals. The capacitive measurements may be processed, such as adjusting for a baseline, performing any other filtering techniques, performing any other processing steps or a combination thereof. Sets of measurements that satisfy a condition may be identified and grouped into contiguous regions. For example, if the condition is a threshold, a measurement may satisfy the threshold when the value of the measurement relative to the threshold (e.g., greater than, equal to, or less than) indicates a potential presence of an input object. By way of another example, if the condition is based on shape, size, polarity, or temporal characteristics, the sets of measurements satisfy the condition when the sets of measurements combined satisfy the characteristics.

In Step 407, a number of unmatched contiguous regions in the set of contiguous regions may be determined based on the measurements from the second resulting signals. For example, absolute capacitive measurements are acquired for the second resulting signals along at least one axis of the sensing region. The absolute capacitive measurements may be processed, such as adjusting for a baseline, performing any other filtering techniques, performing any other processing steps, or a combination thereof.

Additionally, for each contiguous region, a determination is made whether the contiguous region is corroborated by measurements acquired using absolute capacitance sensing. In other words, the contiguous region is a region in which an input object may be present and a determination is made whether an absolute capacitive measurement that corresponds to the region exists and indicates a presence of an input object. If the contiguous region is not corroborated, then the contiguous region is an unmatched contiguous region. In one or more embodiments of the invention, the corroboration may be required for each set of resulting signals received using absolute capacitive sensing. Thus, for example, if the absolute capacitive measurements are along two axes of the sensing region, then both axes must corroborate the contiguous region for the contiguous region to be a matched contiguous region. In some embodiments, only a single axis is sufficient for corroboration.

The unmatched contiguous regions may be counted to determine a total of unmatched contiguous regions. Different techniques may be used to determine whether a contiguous region is an unmatched contiguous region. Below are some example techniques.

In an example technique, a location in the contiguous region may be selected. For example, the location may be selected based on having a peak or maximal value. By way of another example, the location may be selected based on being in the center of the contiguous region. Further, for each subset of sensor electrodes in which absolute capacitance measurements are acquired in Step 403, the corresponding measurement to the location is identified. If the corresponding measurement or measurements do not satisfy a detection threshold, then the contiguous region may be deemed an unmatched contiguous region.

In another example technique, profiles are obtained from the second resulting signals in accordance with one or more embodiments of the invention. The profiles may be segmented in two dimensional intervals. Segmenting the profiles may include iterating through the measurements in the profile and determining which measurements or set of measurements satisfy one or more criteria. For example, if a criterion is a minimal detection threshold, then the measurements in the profile may be iterated through to determine which measurements satisfy the minimal detection threshold. By way of another example, if the criterion is only a single peak value of measurements in each segment, then the local maximal values may be identified. The minimal value between peak values may be identified and used as break points separating segments. In the examples, contiguous measurements between break points and/or that satisfy a detection threshold may be grouped into a segment. Other techniques for segmenting the profiles in one dimensional intervals may be used without departing from the scope of the invention. Based on the segments, a determination may be made whether the contiguous region, projected onto the axis of the segmented profile, is within a segment. Being within a segment may be based on having a threshold amount (e.g., threshold percentage or threshold number) within the segment. If the contiguous region projected onto the axis of the segmented profile is not within the segment, then the contiguous region may be determined to be an unmatched contiguous region.

The above are only two examples for determining whether a contiguous region is an unmatched or matched contiguous region. Other techniques may be used without departing from the scope of the invention.

In Step 409, a determination is made whether the number of unmatched contiguous regions satisfies a threshold number. If the number of unmatched contiguous regions does not satisfy the threshold number, then the flow may proceed to end.

If the number of unmatched contiguous regions satisfies the threshold number, then a mode of operation may be changed in Step 411. In particular, the number of unmatched contiguous may be indicative that the capacitive images obtained may not be accurate of actual input objects in the sensing region. For example, moisture or other condition may cause inaccurate measurements to exist. Thus, the mode of operation may change to start verifying the mutual capacitive measurements and increase accuracy in identifying positional information of input objects. By changing the mode of operation, one or more embodiments may manage a tradeoff between speed and accuracy with the additional processing.

In one or more embodiments of the invention, after any validation of contiguous regions is performed according to the mode of operation, positional information is determined. Positional information may be determined based on the value of the measurements in the contiguous region. For example, the maximal value of the measurement in each contiguous region may correspond to a position of the input object. The relative value of surrounding values may be used to determine the size and shape of the input object. Other information may also be used to determine positional information. The positional information may be reported to the device driver, the host operating system, another component, or a combination thereof. A host operating system, application or another component may use the positional information to perform an action that changes a software or hardware state. For example, a new application may open, a cursor may move, an option may be selected, the host device may enter low power mode, or another action may be performed.

In some embodiments, rather than considering all contiguous regions when counting number of unmatched contiguous regions, only a subset of contiguous regions may be considered. For example, the subset may be neighbors of the contiguous regions. Using a subset corresponding to the neighbors is discussed below and in FIG. 5.

FIG. 5 shows a flowchart in accordance with one or more embodiments of the invention. In Step 501, a first subset of sensor electrodes are driven with first transmitter signals. Further, first resulting signals that are based on the first transmitter signals are received with a second subset of sensor electrodes. In Step 503, second resulting signals are received from the second subset while the second subset are driven with modulated signals. In Step 505, a set of contiguous regions are determined based on the first resulting signals in accordance with one or more embodiments of the invention. Steps 501, 503, and 505 may be performed in a same or similar manner discussed above with reference to Steps 401, 403, and 405 of FIG. 4.

Turning to Step 507, contiguous regions are matched with measurements acquired using second resulting signals. Matching contiguous regions with measurements acquired using second resulting signals may be performed as discussed above with reference to Step 407 of FIG. 4. However, in Step 507, a set of unmatched contiguous regions may be determined, and further processing may be performed on the set.

In Step 509, unmatched neighbor(s) within a threshold distance of an unmatched contiguous regions are determined in accordance with one or more embodiments of the invention. In particular, an unmatched contiguous region is selected. Neighbors that are unmatched contiguous regions and within a threshold distance of the unmatched contiguous region are identified. For example, the threshold distance may define a circular area surrounding the unmatched contiguous region. Any unmatched contiguous regions in the circular area are identified.

In Step 511, a determination is made whether a number of unmatched neighbors satisfy a threshold number in accordance with one or more embodiments of the invention. In particular, the number of unmatched neighbors within the threshold distance are counted. If the number is greater than the threshold number, then the flow proceeds to Step 513.

In Step 513, the mode of operation is changed in accordance with one or more embodiments of the invention. The mode of operation may change as discussed above with reference to Step 411 of FIG. 4. By way of an example, if the number of unmatched neighbors are greater than a threshold number, then the presence of moisture may be detected. Thus, one or more embodiments may perform additional steps in order to differentiate droplets from actual input objects.

Returning to Step 511, if the number of unmatched neighbors does not satisfy a threshold number, then the flow proceeds to Step 515. In Step 515, a determination is made whether another unmatched contiguous region exists. In particular, a determination is made whether an unmatched contiguous region has not been processed in Steps 509 and 511. If another unmatched contiguous region exists, then the next unmatched contiguous region is selected in Step 517 and the flow returns to Step 509 with the next unmatched contiguous region. In other words, neighbors of each unmatched contiguous region may be counted to determine whether any contiguous region has a number of neighbors that satisfy the threshold number. If the number of neighbors does not satisfy the threshold number for any unmatched contiguous region, then the flow may proceed to end without changing the mode of operation.

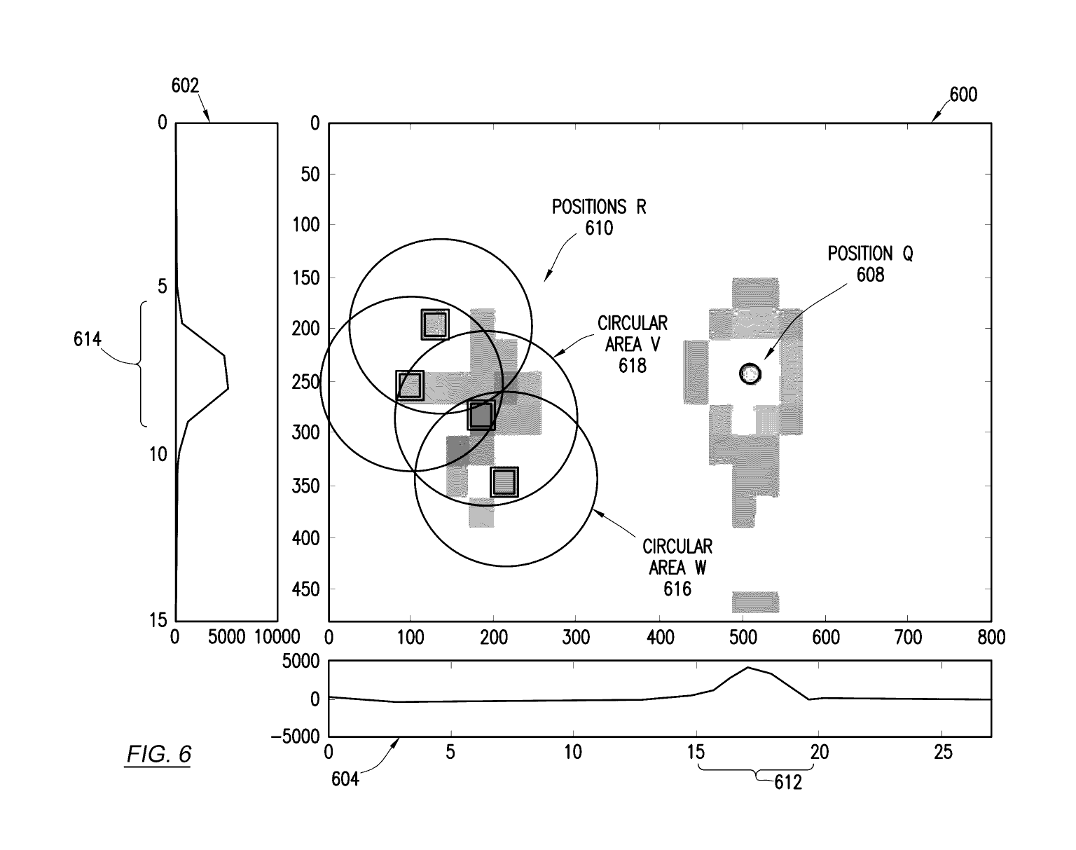

FIG. 6 shows an example in accordance with one or more embodiments of the invention. In FIG. 6, a capacitive image (600) of a sensing region is shown. On the left side of the capacitive image is graph of the y-axis profile (602) and underneath the capacitive image is a graph of the x-axis profile (604). Contiguous regions are shown in the capacitive image as rectangles. The remaining regions of the capacitive image do not have any threshold satisfied.

In the example, consider the scenario in which moisture detection is performed. In particular, a user uses the user's smartphone while cooking in the kitchen. While using the smartphone, the user places a finger at position Q (608) on the sensing region. When the user places a finger at position Q (608), water droplets from cooking drop at positions R (610). In the capacitive image, without additional processing, the water droplets may be indistinguishable from input objects.

In the profiles generated from absolute capacitive sensing, the water droplets are not present. Thus, in the x-axis profile a peak exists only at the columns (612) corresponding to position Q (608) and not corresponding to positions R (610). Because many of the water droplets are in the same row as position Q (608), the y-axis profile at rows (614) have a peak indicating a presence of an input object.

Determining whether moisture exists may include determining that the contiguous region at positions Q (608) is a matched contiguous region based on the positions of the peaks in the y-axis profile (602) and the x-axis profile (604). Contiguous regions at positions R (610) are not corroborated by at least the x-axis profile (604) and, therefore, are unmatched contiguous regions.

Determining whether moisture exists may further be based on the number of neighbors of each unmatched contiguous region. FIG. 6 shows the circular area denoted by the threshold distance for four unmatched contiguous regions (shown as a square in the middle of each circle). Circular area W (616) includes only a few unmatched contiguous regions and does not satisfy the threshold. However, circular area V (618) includes more than a threshold number of unmatched contiguous regions. Thus, moisture is detected.

Because of the detection of moisture, additional processing may be performed on the capacitive image to remove effects corresponding to the detection of moisture. Thus, a more accurate identification of input objects may be obtained in at least some embodiments of the invention. As shown through the example, one or more embodiments may be used to detect presence of moisture and droplets even when at least one actual input object is present in the sensing region.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A processing system for hybrid detection comprising:
a sensor module coupled to a plurality of sensor electrodes, and configured to:
drive a first subset of the plurality of sensor electrodes with transmitter signals,
receive, based on the transmitter signals, first resulting signals from a second subset of the plurality of sensor electrodes,
receive second resulting signals from the second subset while the second subset are driven with modulated signals; and
a determination module configured to:
determine a set of contiguous regions based on the first resulting signals,
determine a number of unmatched contiguous regions in the set of contiguous regions based on measurements processed from the second resulting signals, and
change an operating mode when the number of unmatched contiguous regions satisfies a threshold number.

2. The processing system of claim 1, wherein the determination module is further configured to:
determine that moisture exists when the number of unmatched contiguous regions satisfies the threshold number.

3. The processing system of claim 1, wherein the sensor module is further configured to:
receive third resulting signals from the first subset while the first subset is driven with modulated signals,
wherein the determination module determines the number of unmatched contiguous regions further based on measurements processed from the third resulting signals.

4. The processing system of claim 1, wherein the determination module is further configured to:
select a contiguous region from the set of contiguous regions not matching the measurements processed from the second resulting signals,
wherein determining the number of unmatched contiguous regions comprises limiting the number of unmatched contiguous regions to a plurality of neighbors of the contiguous region within a threshold distance to the contiguous region.

5. The processing system of claim 1, wherein satisfying the threshold number exists when the number of unmatched contiguous regions is equal to the threshold number and when the number of unmatched contiguous regions is greater than the threshold number.

6. The processing system of claim 1, wherein changing the operating mode comprises limiting a number of input objects that are detectable.

7. The processing system of claim 1, wherein the determination module is further configured to:
determine a number of positive contiguous regions in the set of contiguous regions and a number of negative contiguous regions in the set of contiguous regions.

8. A method for hybrid detection comprising:
determining a set of contiguous regions based on first resulting signals obtained by driving a first subset of a plurality of sensor electrodes with transmitter signals and receiving, based on the transmitter signals, the first resulting signals from a second subset of the plurality of sensor electrodes;
determining a number of unmatched contiguous regions in the set of contiguous regions based on measurements processed from the second resulting signals received by driving the second subset with modulated signals; and
changing an operating mode when the number of unmatched contiguous regions satisfies a threshold number.

9. The method of claim 8, further comprising:
determining that moisture exists when the number of unmatched contiguous regions satisfies the threshold number.

10. The method of claim 8, wherein determining the number of unmatched contiguous regions in the set of contiguous regions is further based on measurements processed from third resulting signals received by driving the first subset with modulated signals.

11. The method of claim 8, further comprising:
select a contiguous region from the set of contiguous regions not matching the measurements processed from the second resulting signals,
wherein determining the number of unmatched contiguous regions comprises limiting the number of unmatched contiguous regions to a plurality of neighbors of the contiguous region within a threshold distance to the contiguous region.

12. The method of claim 8, wherein satisfying the threshold number exists when the number of unmatched contiguous regions is equal to the threshold number and when the number of unmatched contiguous regions is greater than the threshold number.

13. The method of claim 8, wherein changing the operating mode comprises limiting a number of input objects that are detectable.

14. The method of claim 13, further comprising:
determining a number of positive contiguous regions in the set of contiguous regions and a number of negative contiguous regions in the set of contiguous regions.

15. An input device for hybrid detection comprising:
a plurality of sensor electrodes comprising a first subset of sensor electrodes and a second subset of the plurality of sensor electrodes; and
a processing system configured to:
determine a set of contiguous regions based on resulting signals obtained by driving the first subset of the plurality of sensor electrodes with transmitter signals and receiving, based on the transmitter signals, first resulting signals from the second subset of the plurality of sensor electrodes,
determine a number of unmatched contiguous regions in the set of contiguous regions based on measurements processed from second resulting signals received by driving the second subset with modulated signals, and
change an operating mode when the number of unmatched contiguous regions satisfies a threshold number.

16. The input device of claim 15, wherein the processing system is further configured to:
determine that moisture exists when the number of unmatched contiguous regions satisfies the threshold number.

17. The input device of claim 15, wherein determining the number of unmatched contiguous regions in the set of contiguous regions is further based on measurements processed from third resulting signals received by driving the first subset with modulated signals.

18. The input device of claim 15, wherein the processing system is further configured to:
select a contiguous region from the set of contiguous regions not matching the measurements processed from the second resulting signals,
wherein determining the number of unmatched contiguous regions comprises limiting the number of unmatched contiguous regions to a plurality of neighbors of the contiguous region within a threshold distance to the contiguous region.

19. The input device of claim 15, wherein satisfying the threshold number exists when the number of unmatched contiguous regions is equal to the threshold number and when the number of unmatched contiguous regions is greater than the threshold number.

20. The input device of claim 15, wherein changing the operating mode comprises limiting a number of input objects that are detectable.
